(19) United States
(12) Patent Application Publication
(10) Pub. No.: US 2015/0350109 A1
(43) Pub. Date: Dec. 3, 2015

(54) MEDICAL IMAGING SYSTEM AND METHOD FOR THE OPERATION THEREOF WITH SHARED COMPUTING RESOURCES

(71) Applicant: Siemens Aktiengesellschaft, Muenchen (DE)

(72) Inventor: Andreas Kiepfer, Erlangen (DE)

(73) Assignee: Siemens Aktiengesellschaft, Muenchen (DE)

(21) Appl. No.: 14/723,896

(22) Filed: May 28, 2015

(30) Foreign Application Priority Data
May 28, 2014 (DE) 102014210233.2

(51) Int. Cl. H04L 12/911; H04L 12/24

(52) U.S. Cl. CPC H04L 47/827; H04L 41/0803; G06Q 50/24

(57) ABSTRACT

The invention relates to a method for providing computing resources for at least one medical imaging system and/or image processing system and to a medical imaging system and/or image processing system, a computer program and a machine-readable storage medium. The imaging system and/or image processing system exchanges (4) data via a local network (1), wherein the computing resources are provided locally on at least one computer (2) which is assigned to the imaging system and/or image processing system and/or are provided centrally for all imaging systems and/or imaging processing systems connected via the local network (1) on at least one computer (2) which is disposed in at least one Cloud (3), so that the computing resources can be shared (5), if necessary temporarily, between the imaging systems and/or image processing system. Thus sufficient computing resources are provided to prevent performance bottlenecks and also to make local software upgrades superfluous.

### BACKGROUND OF THE INVENTION

1. Field of the Invention

The present invention concerns the provision of computing resources for a least one medical imaging system and/or image processing system, and a computer-readable storage medium encoded with programming instructions for implementing such a method.

2 Description of the Prior Art

For imaging in magnetic resonance (MR) tomography a high outlay in computing time and resources is necessary for the operations and computations associated with such imaging. The image processing is based on locally installed computers with a number of computing units. In addition the computing of the sequence and parameter settings is very complex, so that the computer must also be equipped with a number of central processors. Local computers, which can be upgraded later by additional upgrades, are usually delivered with any MR system. Complex operations often result in a performance bottleneck. Each computer acts autonomously in relation to its computing resources and this has a disadvantageous effect, especially in the image processing or importing or converting of old sequences.

It is therefore extremely problematic that computing resources are not shared between individual computers, even though the resources are often not completely utilized. Computers are therefore upgraded by purchasing upgrades in order to remedy the performance bottlenecks.

### SUMMARY OF THE INVENTION

An object of the invention is to provide the option of providing sufficient computing resources to prevent performance bottlenecks and to render local software upgrades for the purposes of resource procurement or expansion superfluous.

The object is achieved in accordance with the invention by the method described below. Features, advantages or alternate forms of embodiment mentioned here are also applicable to the other aspects of the invention described below. The functional features of the method are embodied in corresponding physical modules, namely hardware modules.

The above object is achieved in accordance with a first aspect of the invention by a method for providing computing resources for at least one medical imaging system and/or image processing system, wherein the imaging system and/or image processing system exchanges data over a local network, wherein the computing resources are provided locally on at least one computer which is assigned to the imaging system and/or image processing system and/or are provided centrally for all imaging systems and/or image processing systems connected via the local network which is disposed in at least one Cloud, so that the computing resources can be shared if necessary temporarily between the imaging systems and/or image processing systems.

Thus computing resources are made available to the individual systems such that individual computers can make their computing resources available on the other computers. This enables the computing resources to be shared between the individual systems or computers temporarily if required. In such cases the computing resources are preferably predefined and/or configurable. If the computing resources are predefined then it is already established at the beginning of a computation or of a data exchange which maximum computing resource capacity is available. If the computing resources are configurable, then specific computing resources can be added or also removed any time. The latter is preferably done on demand. The imaging system and/or image processing system is preferably a medical modality such as an MR device or a CT device or another imaging modality. Such an imaging system and/or image processing system can also be a network of individual devices.

The term “shared” primarily means use or sharing of computing resources at all times, as well as, in terms of time, utilization or sharing of computing resources if, during a complex operation such as e.g. in the processing of an image or importing and/or conversion of a sequence, a performance bottleneck is present in the imaging system and/or image processing system. The sharing of computing resources thus relates to the provision of an option for accessing physical or technical resources.

The computing resources preferably involve software-based resources, such as updates, upgrades, new versions of software or sections (such as patches). In accordance, with an alternate embodiment, hardware resources are also to be included, such as e.g. network support, computing power, memory modules etc.

The local network can be a Local Area Network (LAN). It can be publicly accessible or a protected private network (for example a network in a clinical department or within an association of clinics). By contrast the term “central” designates that type of technical network structure in which there can be access by a number of imaging systems and/or image processing systems to one or more centrally-disposed and linked-in units or entities. This can be implemented for example in the form of a Cloud with corresponding interfaces and protocols.

In a preferred exemplary embodiment of the invention the computing resources are intended for carrying out computations as part of an image acquisition and/or processing of an image. Thus the computing resources can be provided by imaging systems within a local network and can thus profit from one another. The computing resources are preferably intended for carrying out a computation of the sequence and/or of the parameter setting for a magnetic resonance tomograph. The method can thus be simply implemented or applied for medical methods.

In another preferred exemplary embodiment of the invention the computer preferably has a plurality of computing units. The user or the customer thus has powerful computing resources available, since the more computing units are available, the more efficient such a network is and exceeds the power of an individual system by an order of magnitude. The computing resource preferably has a central processor and/or a graphics processor. Thus not only complex computations can be carried out, but also graphics processing and presentations are possible. Each computing unit preferably comprises a central processing unit (CPU) and/or a graphics processing unit (GPU). The central processing unit (CPU) and the graphics processing unit (GPU) are responsible for the performance or for the speed of the computations and/or imaging.

In another preferred exemplary embodiment of the invention, the Cloud is disposed in the local network, so that the computing resources are provided within the local network. In accordance with other preferred exemplary embodiments of the invention, the imaging system and/or image processing system does not have its own computing resources.

In another preferred exemplary embodiment of the invention, the Cloud is provided by an external service provider outside the local network, so that the computing resources are provided outside the local network. There can then advantageously be access via a secured network from the individual computers of the local network or centrally within the local network to the Cloud outside the local network.

In accordance with a second aspect of the invention the object is achieved by a medical imaging system and/or image processing system, wherein data is able to be exchanged in the imaging system and/or image processing system via a local data network, and wherein the imaging system and/or image processing system is configured to carry out a method in accordance with the first aspect of the invention.

A system is thus provided that can share and provide computing resources independently of the type of system and from the location of the system within a network of systems. In such cases it is irrelevant whether the computing resources are provided by a local or an external Computation Cloud or by the local computers themselves, which set up a Computation Cloud within a network and share their computing resources. Each of these options can be provided with the same system and there is advantageously no specialization uniquely defined on the system. In addition a simple stocking up of computing resources is possible by expanding the Cloud. Here as well, it is irrelevant whether the Cloud is made available locally, externally or by service providers. The user or the customer has new, more powerful computing resources available without delay or without any downtime. Thus the efficiency of such a networked arrangement exceeds the power of an individual system by an order of magnitude. Fault tracing, maintenance and upgrades can all take place in the local or external Cloud and thus no local software upgrade is necessary.

The present invention also encompasses a non-transitory, computer-readable data storage medium encoded with programming instructions that, when the storage medium is loaded into computers as described above, causes those computers to execute the method according to the invention, as also described above.

It is not necessary for all steps of the method to be executed by one and the same computer-based entity. The steps can be executed on different devices or entities. It is also possible for individual sections of the methods described here to be able to be executed in one commercially-available unit and the remaining components in another commercially-available unit—a distributed system so to speak. The sequence of the method steps can also be varied if necessary.

### BRIEF DESCRIPTION OF THE DRAWINGS

FIG. 1 shows an overview of a local network in accordance with a first preferred exemplary embodiment of the invention;

FIG. 2 shows an overview of a local network in accordance with a second preferred exemplary embodiment of the invention;

FIG. 3 shows an overview of a local network in accordance with a third preferred exemplary embodiment of the invention.

FIG. 4 shows an example of data flow of the method in accordance with a fourth preferred exemplary embodiment of the invention.

### DESCRIPTION OF THE PREFERRED EMBODIMENTS

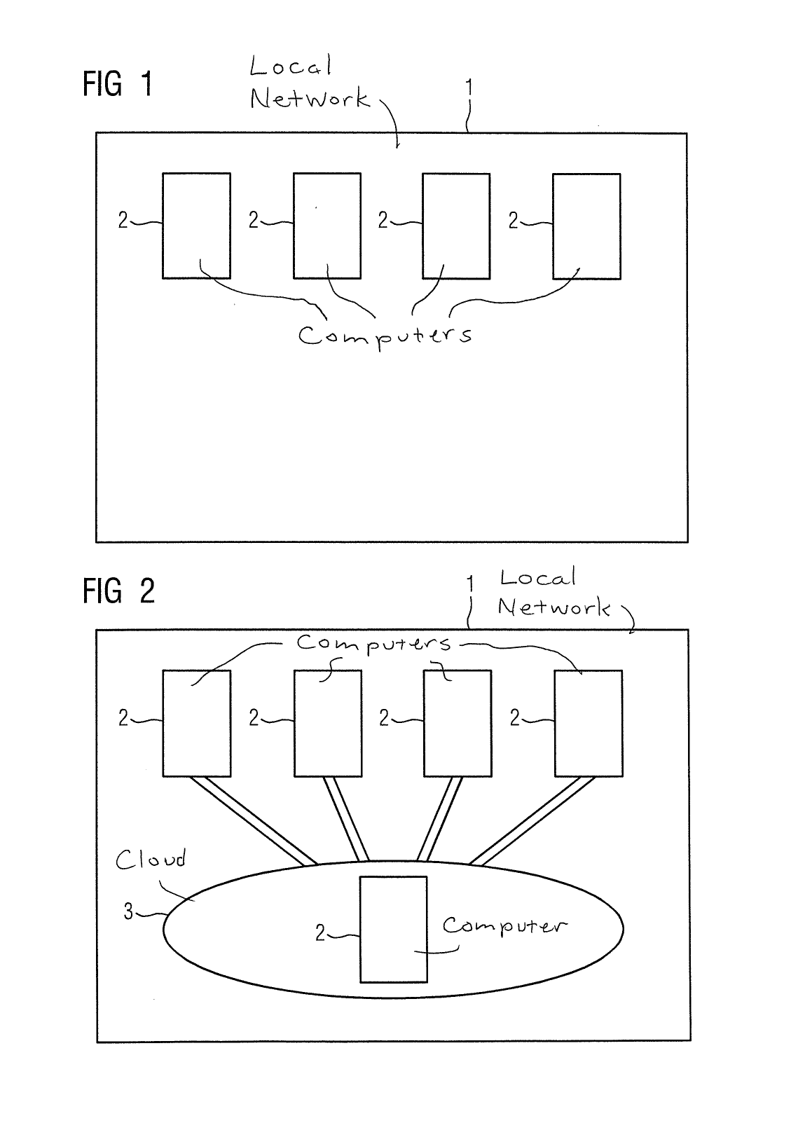

FIG. 1 shows an overview-type diagram of a local network in accordance with a first preferred exemplary embodiment of the invention. In the local network 1 data is exchanged between the individual computers 2, wherein the computing resources are provided locally on at least one computer 2. In the first preferred exemplary embodiment of the invention four computers 2 are provided. In this case the computing resources are not restricted to a specific type of system and only the pure computer resources are shared. In this first preferred exemplary embodiment of the invention each system makes its computing resources available in the local network 1.

FIG. 2 likewise shows an overview-type diagram of a local network in accordance with a second preferred exemplary embodiment of the invention. Unlike in FIG. 1, a Cloud 3 is provided within the local network 1, so that the computing resources are provided centrally on at least one computer 2 for all imaging systems and/or image processing systems connected via the local network 1. If necessary computing resources can be shared temporarily between the imaging and/or image processing systems, wherein the computing resources are provided centrally by a local Cloud 3, which in this second preferred exemplary embodiment also comprises one computer 2. Computing resources are involved here which are available at a central point in the local network, since none of the individual systems has its own computing resources which can make available.

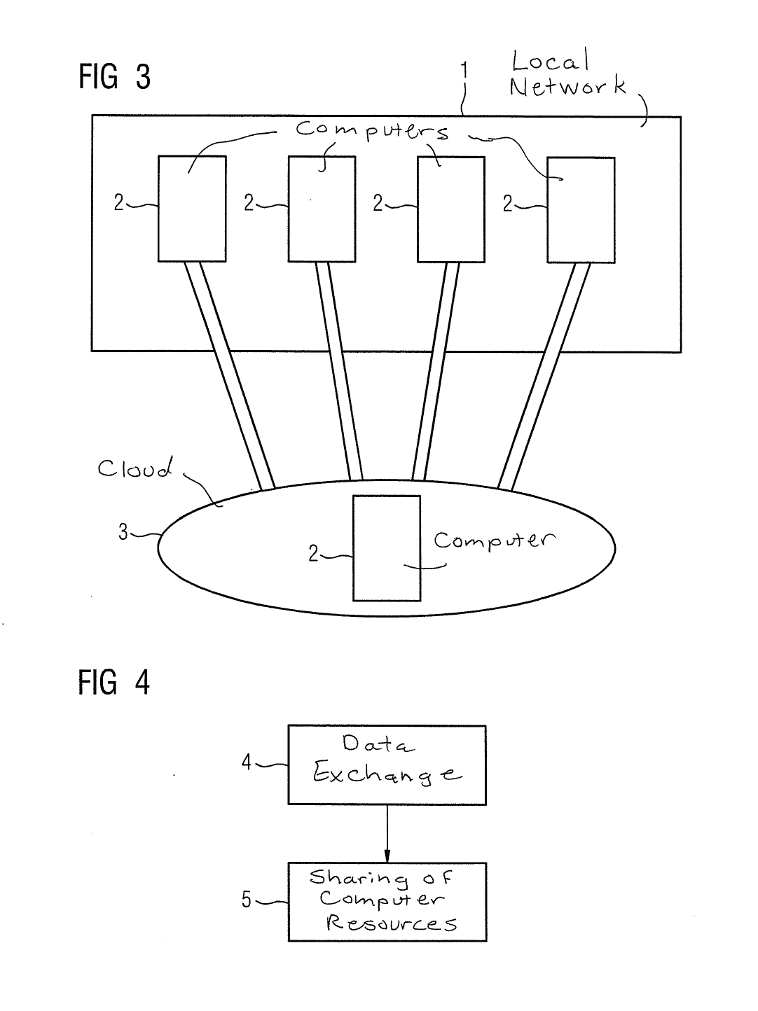

FIG. 3 shows an overview-type diagram of a local network in accordance with a third preferred exemplary embodiment of the invention. Unlike in FIG. 2, the Cloud 3 is disposed outside the local network 1 and comprises a computer 2. Each of the four computers 2 in the local network 1 can connect to the computer 2 from the external Cloud 3, so that the computing resources are provided outside the local network 1. There is access here by means of a secure network. In this third preferred exemplary embodiment none of the installed systems has its own computing resources and there are just as few computing resources in the local network 1. Instead the computing resources are provided externally by a certified service provider and thus only the actual hardware control software is available on the systems. Image processing and other very complex computations run on the external computing resources by means of a secure network. In accordance with other preferred exemplary embodiments the computing can also run over the Internet.

FIG. 4 shows a data flow of a method in accordance with a fourth preferred exemplary embodiment of the invention. In a first step data is exchanged 4 in the local network. Then in a second step computing resources are shared 5, if necessary temporarily between the imaging systems and/or image processing systems.

In conclusion it should be pointed out that the description of the invention and the exemplary embodiments are basically not to be understood as restrictive in respect of a specific physical realization of the invention. For a person skilled in the art it is in particular obvious that the invention can be realized here distributed in software and/or hardware and/or to a number of physical products—also especially computer program products.

Although modifications and changes may be suggested by those skilled in the art, it is the intention of the inventor to embody within the patent warranted hereon all changes and modifications as reasonably and properly come within the scope of his contribution to the art.

I claim as my invention:

1. A method for providing computing resources for at least one medical system selected from the group consisting of medical imaging systems and medical image processing system, comprising:
via a local network, communicating between at least one first computer and said at least one medical imaging system to provide computing resources from said at least one first computer to said at least one medical system;
via a cloud network, also providing computer resources from a second computer to said at least medical system; and
configuring said first computer and said second computer to divide provision of said computing resources to said at least one medical system.

2. A method as claimed in claim 1 comprising providing said computing resources to execute calculations in at least one of a medical image data acquisition and a medical image processing performed by said at least medical system.

3. A method as claimed in claim 1 wherein said medical system is a magnetic resonance tomography apparatus, and comprising providing said computing resources for executing calculations in a pulse sequence for acquiring magnetic resonance data, or for parameter settings in said pulse sequence.

4. A method as claimed in claim 1 wherein said second computer is comprised of a plurality of individual computing units.

5. A method as claimed in claim 1 wherein said computing resources comprise at least one of centralized data processing and graphics processing.

6. A method as claimed in claim 1 comprising configuring said local network to include the cloud network, and thereby providing said computing resources from said cloud network via said local network.

7. A method as claimed in claim 1 comprising configuring said second computer and said at least one medical system to access said cloud network as an external service provider outside of said local network, with said computing resources being provided by said cloud network outside of said local network.

8. A medical system comprising:
a medical apparatus comprising at least one of a medical imaging apparatus and a medical image processing apparatus;
at least one first computer and said at least one medical imaging system being configured to communicate via a local network to provide computing resources from said at least one first computer to said at least one medical system;
a second computer configured to also provide computer resources to said at least medical system via a cloud network; and
said first computer and said second computer being configured to divide provision of said computing resources to said at least one medical system.

9. A non-transitory, computer-readable data storage medium encoded with programming instructions, said storage medium being distributed among first and second computers of a medical system, said medical system comprising at least one of a medical imaging apparatus and a medical image processing apparatus, said programming instructions causing said first and second computers to:
via a local network, communicate between said first computer and said medical imaging system to provide computing resources from said at least one first computer to said at least one medical system;
via a cloud network, also provide computer resources from the second computer to said at least medical system; and
divide provision of said computing resources to said at least one medical system between said first computer and said second computer.
